(19) United States
(12) Patent Application Publication
(10) Pub. No.: US 2012/0081513 A1
(43) Pub. Date: Apr. 5, 2012

(54) Multiple Parallax Image Receiver Apparatus

(76) Inventor: Masahiro Yamada, Tokyo (JP)

(21) Appl. No.: 13/074,857

(22) Filed: Mar. 29, 2011

(30) Foreign Application Priority Data
Oct. 1, 2010 (JP) 2010-224081

(51) Int. Cl. H04N 13/00

(52) U.S. Cl. 348/43; 348/E13.002

(57) ABSTRACT

A multiple parallax image receiver apparatus according to an embodiment includes: an image signal receiver and processor unit configured to receive an image signal; a multiple parallax image generator unit configured to generate first multiple parallax images based on the image signal; a multiple parallax image receiver and converter unit configured to receive multiple parallax image signals and convert the received multiple parallax image signals to second multiple parallax images; a message generator unit configured to generate third multiple parallax images containing a message to be displayed on a display device when power supply is turned on; a selector unit configured to select and output the third multiple parallax images when the power supply is turned on, and then select and output the first or second multiple parallax images; and a stereoscopic image converter unit configured to convert the multiple parallax images output from the selector unit to an image for stereoscopic image display.

### CROSS-REFERENCE TO RELATED APPLICATION

This application is based upon and claims the benefit of priority from prior Japanese Patent Application No. 2010-224081 filed on Oct. 1, 2010 in Japan, the entire contents of which are incorporated herein by reference.

### FIELD

Embodiments described herein relate generally to a multiple parallax image receiver apparatus.

### BACKGROUND

In recent years, multiple parallax image (three-dimensional image) receiver apparatuses have been developed and sold.

However, the amount of software for three-dimensional image is small. Therefore, a multiple parallax image receiver apparatus which receives and decodes a two-dimensional image signal which has been transmitted and encoded, then generates multiple parallax images from the decoded two-dimensional image signal, and displays the multiple parallax images is proposed.

Furthermore, a stereoscopic display apparatus which determines whether input data is two-dimensional image data having no depth information, three-dimensional data obtained by adding depth information to a two-dimensional image, or parallax image data, and which generates a three-dimensional image corresponding to each of them is proposed. However, it is not disclosed that the stereoscopic display apparatus generates multiple parallax images from an image delivered via broadcast or a network.

### BRIEF DESCRIPTION OF THE DRAWINGS

FIG. 1 is a block diagram showing a multiple parallax image receiver apparatus according to a first embodiment;

FIG. 2 is a diagram showing an example of a two-dimensional image;

FIG. 3 is a diagram for explaining the case where depth information is generated from the two-dimensional image shown in FIG. 2;

FIG. 4 is a diagram showing the case where nine parallax images having a resolution of 1280×720 on a screen having a resolution of 3840×2160;

FIG. 5 is a diagram showing a pixel array in the case where nine parallax images are displayed on the screen shown in FIG. 4;

FIG. 6 is a diagram showing the case where nine parallax images 30a to 30i disposed on one screen on the basis of nine-parallax image signals 3a, 3b, 3c and 3d are separated;

FIG. 7 is a diagram showing a pixel array in the case where nine parallax images 30a to 30i shown in FIG. 6 are displayed on a screen of 1280×720; and

FIG. 8 is a block diagram showing a multiple parallax image receiver apparatus according to a second embodiment.

### DETAILED DESCRIPTION

A multiple parallax image receiver apparatus according to an embodiment includes: an image signal receiver and processor unit configured to receive an image signal; a multiple parallax image generator unit configured to generate first multiple parallax images based on the image signal received by the image signal receiver and processor unit; a multiple parallax image receiver and converter unit configured to receive multiple parallax image signals and convert the received multiple parallax image signals to second multiple parallax images; a message generator unit configured to generate third multiple parallax images containing a message to be displayed on a display device when power supply is turned on; a selector unit configured to select and output the third multiple parallax images when the power supply is turned on, and then select and output the first or second multiple parallax images based on a control signal; and a stereoscopic image converter unit configured to convert the multiple parallax images which are output from the selector unit to an image for stereoscopic image display.

### First Embodiment

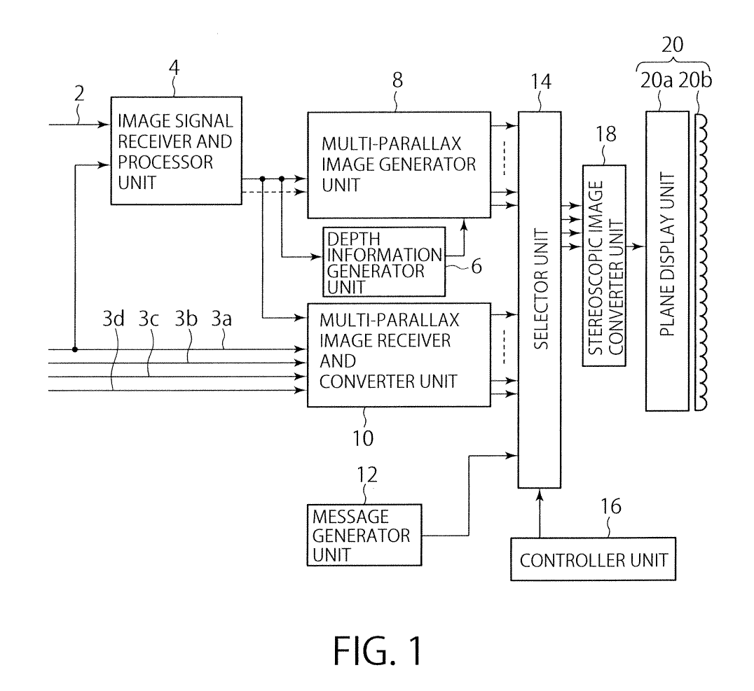

A multiple parallax image receiver apparatus according to a first embodiment is shown in FIG. 1. The multiple parallax image receiver apparatus according to the present embodiment includes an image signal receiver and processor unit 4, a depth information generator unit 6, a multiple parallax image generator unit 8, a multiple parallax image receiver and converter unit 10, a message generator unit 12, a selector unit 14, a controller unit 16, a stereoscopic image converter unit 18, and a plane display device 20.

The plane display device 20 includes a display panel (plane display unit) 20a having pixels arranged in a matrix form, and an light ray controlling element 20b disposed to be opposed to the display panel 20a and having a plurality of exit pupils to control light rays from the pixels. As the display panel 20a, for example, a liquid crystal panel, a plasma display panel or the like can be used. The light ray controlling element 20b is typically called parallax barrier as well. The exit pupils in the light ray controlling element 20b control light rays to show a different image to the viewer according to the angle even in the same location.

Specifically, when giving only horizontal disparity, a slit plate having a plurality of slits or a lenticular sheet (cylindrical lens array) is used. When the vertical disparity is also included, a pinhole array or a lens array is used. In other words, a slit in the slit plate, a cylindrical lens in the cylindrical lens array, a pinhole in the pinhole array, or a lens in the lens array serves as each exit pupil. In the present embodiment and a second embodiment described later, the plane display device includes a light ray controlling element having a plurality of exit pupils. Alternatively, however, a plane display device which generates a parallax barrier electronically by using a transmission type liquid crystal display device or the like and exerts electronic variable control as to the shape and location of a barrier pattern may be used as long as an image for stereoscopic image display described later can be displayed.

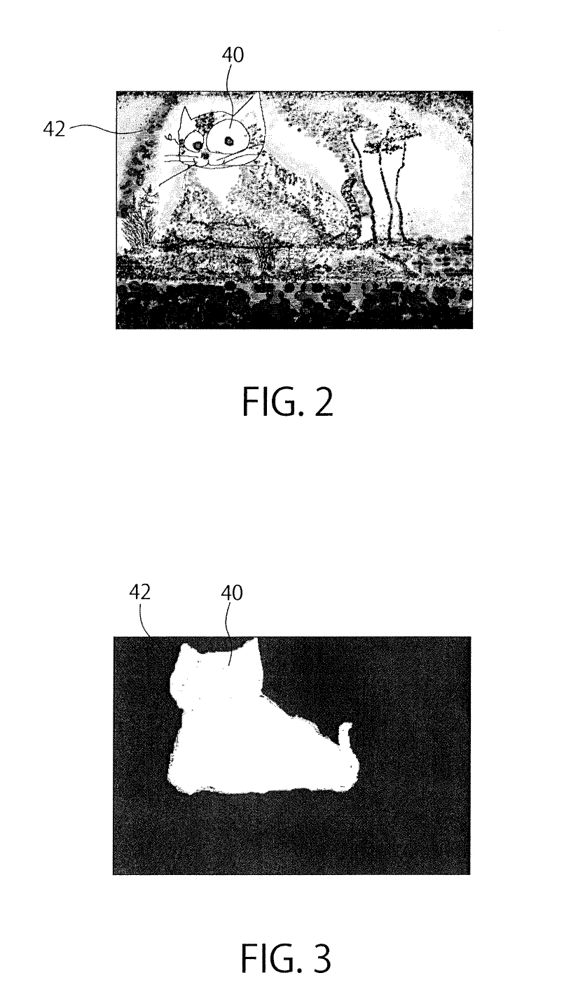

The image signal receiver and processor unit 4 receives and decodes an encoded two-dimensional image signal 2 or an encoded multiple parallax image signal 3a, and generates a decoded two-dimensional image signal or multiple parallax image signal. The decoded two-dimensional image signal is displayed as shown in, for example, FIG. 2.

The depth information generator unit 6 analyzes the decoded two-dimensional image signal or multiple parallax image signal, and generates depth information of the image. For example, the depth information generator unit 12 generates depth information of an object 40 on the basis of the two-dimensional image shown in FIG. 2. The generation of the depth information is performed by using a well-known method, for example, a method described in JP-A-2000-261828 (KOKAI). According to this method, depth information of an image 40 of a two-dimensional image signal is generated as shown in FIG. 3 by separating a signal to a signal of a background area 42 shown in FIG. 2 and a signal of an image 40 in a remaining area, calculating a representative motion vector of the background area 42 on the basis of a motion vector of a two-dimensional image and a motion vector of the background area 42, subtracting the representative motion vector from the motion vector of the two-dimensional image to calculate a relative motion vector, and using the relative motion vector.

The multiple parallax image generator unit 8 generates multiple parallax images seen from, for example, nine directions by using the depth information generated by the depth information generator unit 6. An object which is indicated to be located on this side by depth information (for example, the object 40 shown in FIG. 2) looks shifted to the right side as compared with an object in the background 42, when seen from the left direction. Therefore, the multiple parallax image generator unit 8 performs processing of shifting to the right side on an image of the object 40 and generates a parallax image seen from the left direction. In this way, the multiple parallax image generator unit 8 generates parallax images seen from nine locations disposed in order from the left to the right in the horizontal direction. Properly speaking, the image of the background ought to be visible when performing processing of shifting the location of the object. Since its information is not contained in the input image, however, the processing of shifting the location of the object becomes processing of simply distorting the image. By the way, if depth information is contained in the image signal transmitted from the image signal receiver and processor unit 4, then the multiple parallax image generator unit 8 generates multiple parallax images by using the image signal (the image signal indicated by a dashed line) without using the depth information generated by the depth information generator unit 6.

The multiple parallax image receiver and converter unit 10 converts, for example, multiple parallax image signals 3a, 3b, 3c and 3d which are input, to multiple parallax images suitable for display in the plane display device 20, and outputs the multiple parallax images. For example, it is supposed that the number of parallaxes of the multiple parallax image signals which are input is N and the number of parallaxes suitable for the display in the plane display device 20 is n. If N>n, then the multiple parallax image receiver and converter unit 10 thins the multiple parallax image signals which are input and outputs multiple parallax images having the number n of parallaxes. If N<n, then the multiple parallax image receiver and converter unit 10 generates and outputs multiple parallax images having the number n of parallaxes by using the multiple parallax image signals which are input and using interpolation. If N=n, then the multiple parallax image receiver and converter unit 10 outputs the multiple parallax image signals which are input, as they are as multiple parallax images. By the way, the multiple parallax image signals 3a, 3b, 3c and 3d may be image signals delivered via broadcast or a network, or may be reproduced video image signals or multiple parallax image signals generated by a PC (Personal Computer). If the multiple parallax image signals 3a, 3b, 3c and 3d which are input are encoded image signals, therefore, the multiple parallax image receiver and converter unit 10 decodes the encoded image signals, and converts the decoded multiple parallax image signals to multiple parallax images suitable for display, and outputs the resultant multiple parallax images. In the present embodiment, the multiple parallax image receiver and converter unit 10 has terminals supplied with the multiple parallax image signals 3a, 3b, 3c and 3d, i.e., four input terminals.

When the power supply is turned on, the message generator unit 12 generates clear multiple parallax images to be displayed on the plane display device 20. If the viewer is outside a range of a zone (viewing zone) where a normal stereoscopic image is seen, a message informing the viewer of it is contained in the multiple parallax images. This message may be an image containing speech, or may be an alarm image. And this message is displayed so as not to be invisible to a viewer in the viewing zone. In other words, a signal of the message is adapted to be output from pixels of an exit source of light rays illuminated from the plane display device 20 to the outside of the viewing zone. The message generator unit 12 may previously store clear multiple parallax images for display on the plane display device 20 and output the multiple parallax images accompanied by the stored message when the power supply is turned on.

The selector unit 14 selects either the multiple parallax images which are output from the multiple parallax image generator unit 8 or the multiple parallax images which are output from the multiple parallax image receiver and converter unit 10 on the basis of a control signal supplied from the controller unit 16, and sends the selected multiple parallax images and the multiple parallax images generated by the message generator unit 12 to the stereoscopic image converter unit 18.

The controller unit 16 generates the control signal on the basis of a signal generated by a viewer's operation, for example, a signal generated (for example, a signal using infrared rays) generated by a viewer's operation on a remote controller which is not illustrated. The controller unit 16 can control the selector unit 14 by using the control signal. In addition, when the power supply is turned on, the controller unit 16 selects the multiple parallax images generated by the message generator unit 12 and sends it to the stereoscopic image converter unit 18.

As to the multiple parallax images sent via the selector unit 14, the stereoscopic image converter unit 18 rearranges pixels which are components of each parallax image per every exit pupil of the plane display device 20, and sends an image for stereoscopic image display to the plane display device 20. By the way, if each parallax image is formed of three subpixels (for example, R (red), G (green) and B (blue) subpixels), the stereoscopic image converter unit 18 performs processing of rearranging information of pixel units by taking a subpixel as the unit and generates an image for stereoscopic image display. As described in JP-A-2006-98779 (KOKAI), the stereoscopic image converter unit 18 may perform conversion to a format (for example, tile images) suitable for transmission or compression of parallax images by putting together only actually required parts of parallax images.

The plane display device 20 displays the image for stereoscopic image display sent from the stereoscopic image converter unit 18.

The multiple parallax images generated by the multiple parallax image generator unit 8 become pseudo stereoscopic images in principle. On the other hand, if images are obtained by shooting with nine cameras or images are generated by CG (computer graphics), then images viewed from nine directions can be obtained faithfully. If they are displayed intact on the plane display device 20, therefore, clearer stereoscopic image can be seen.

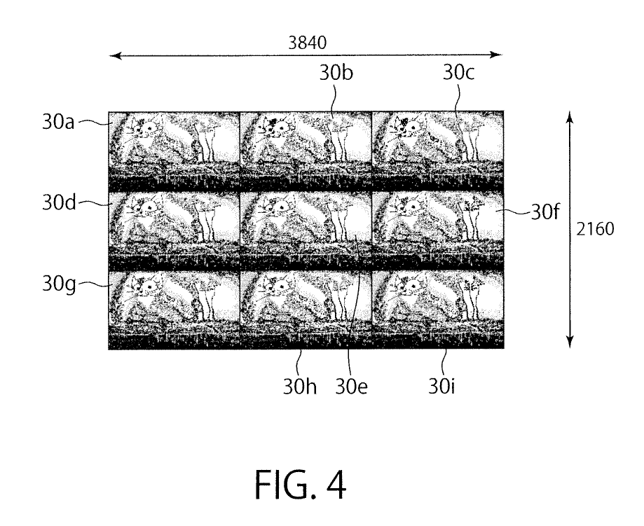

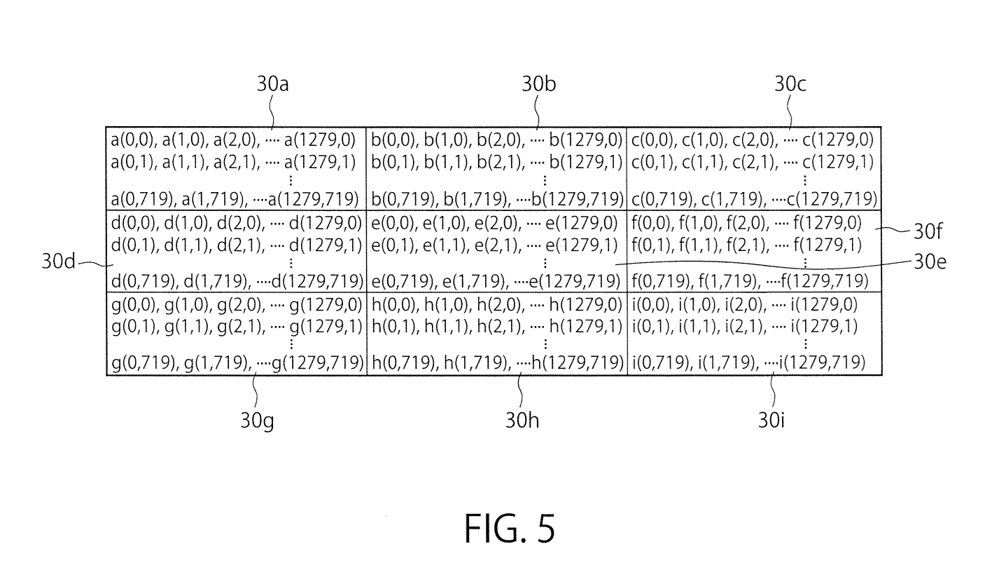

Supposing that the multiple parallax image signals 3a, 3b, 3c and 3d are image signals of nine parallaxes, the nine-parallax image signals simply become images corresponding to nine parallax images of an ordinary image (two-dimensional image) and the number of pixels which is nine times that of the ordinary image becomes necessary. For example, if the number of pixels in the ordinary image is 1280×720, an image which is in the number of pixels nine times as many as 1280×720 is input to four input terminals of the multiple parallax image receiver and converter unit 10. Supposing that the number of pixels is increased to, for example, three times in each of the vertical direction and horizontal direction, an image having 3840×2160 pixels shown in FIG. 4 is input to the four input terminals of the multiple parallax image receiver and converter unit 10. This number of pixels is just four times as many as that in full high vision television (1920×1080), and it can be received at four terminals of the HDMI (High-Definition Multimedia Interface) capable of performing image transmission of full high vision television or DVI (Digital Visual Interface). The image shown in FIG. 4 is formed of nine parallax images 30a to 30i. A pixel array in the case where each parallax image 30j (j=a, . . . , i) is displayed as an image shown in FIG. 4 is shown in FIG. 5. A notation j(l, k) indicates a luminance value of a pixel in an lth column and a kth row of a parallax image 30j.

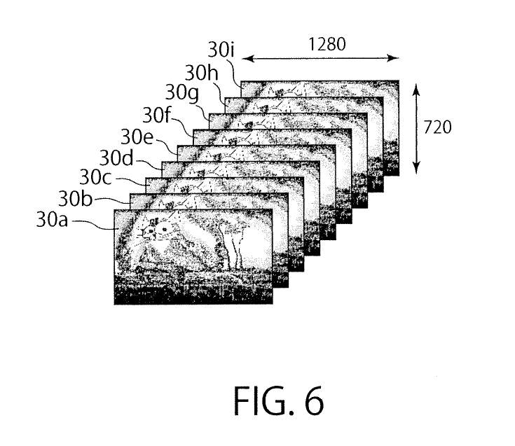

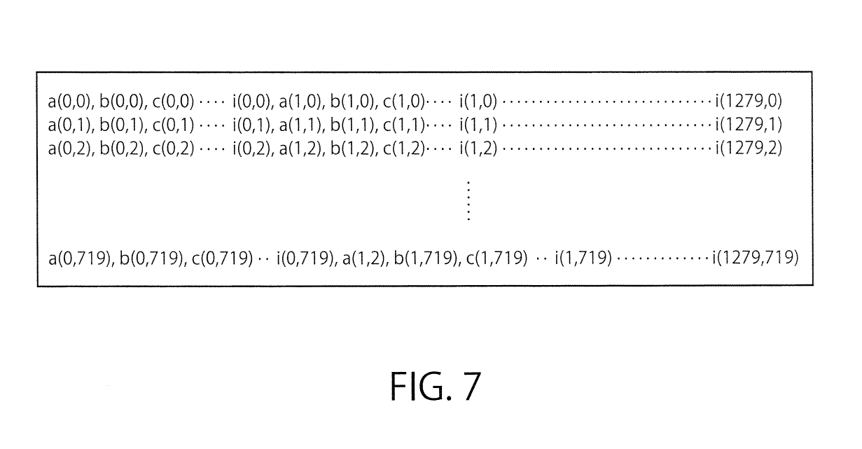

For example, if the resolution of the display panel 20 is 640×360, then nine parallax images can be disposed in 1920×1080 pixels corresponding to nine parallaxes. In other words, images of nine parallaxes are contained in one HDMI terminal. The input terminal of the image receiver and processor unit 4 in the present embodiment is an example of the case where one HDMI terminal is used. Here, an ordinary image and an image of nine parallax images (in this case, nine images each having 640×360 pixels) are received. The image receiver and processor unit 4 may superpose OSD (On Screen Display) or insert graphics. Nine parallax images 30a to 30i disposed on one screen on the basis of the output of the image receiver and processor unit 4 or the nine parallax image signals 3a, 3b, 3c and 3d which are input to the multiple parallax image receiver and converter unit 10 are separated as shown in FIG. 6. A pixel array of nine parallax images 30a to 30i shown in FIG. 6 in this case is shown in FIG. 7. A notation j(l, k) indicates a luminance value of a pixel in an Ith column and a kth row of a parallax image 30j.

Operation of the multiple parallax image receiver apparatus according to the present embodiment will now be described.

First, when the power supply of the multiple parallax image receiver apparatus according to the present embodiment is turned on, the multiple parallax images containing the message generated by the message generator unit 12 is selected by the selector unit 14, sent to the stereoscopic image converter unit 18, and converted to an image for stereoscopic image display by the stereoscopic image converter unit 18. A stereoscopic image is displayed by the plane display device 20. The stereoscopic image displayed at this time becomes a clear image having a cubic effect, because it is based on the clear multiple parallax images generated by the message generator unit 12. Furthermore, the multiple parallax images containing the message generated by the message generator unit 12 contains the message which informs the viewer that the viewer is located outside the range of a zone (viewing zone) where a normal stereoscopic image is visible. When the viewer is located outside the viewing zone, therefore, it becomes possible for the viewer to know it, view in the viewing zone, and see a normal stereoscopic image.

As for the display of a stereoscopic image by using multiple parallax images containing the message generated by the message generator unit 12, the controller unit 16 may exercise control to display the stereoscopic image for a predetermined time after the power supply is turned on and then select the multiple parallax images which are output from the multiple parallax image generator unit 8 or the multiple parallax image receiver and converter unit 10.

Furthermore, the controller unit 16 may be controlled to select the multiple parallax images which are output from the multiple parallax image generator unit 8 or the multiple parallax image receiver and converter unit 10, by a viewer's operation of, for example, a remote controller during the display of a stereoscopic image using the multiple parallax images generated by the message generator unit 12.

The message informing the viewer that the viewer is located outside the viewing zone may be displayed on the plane display device 20 even after the multiple parallax images which are output from the multiple parallax image generator unit 8 or the multiple parallax image receiver and converter unit 10 are selected.

If the multiple parallax images which are output from the multiple parallax image generator unit 8 or the multiple parallax image receiver and converter unit 10 are selected by the selector unit 14, then the selected multiple parallax images are converted to an image for stereoscopic image display by the stereoscopic image converter unit 18 and a stereoscopic image is displayed by the plane display device 20.

According to the present embodiment, it is possible to receive an image delivered via broadcast or a network and convert the image to multiple parallax images and display the multiple parallax images. In addition, it is possible to convert the multiple parallax images which are input, to multiple parallax images suitable for display and display the resultant multiple parallax images. In addition, it is possible to display a clear image having a cubic effect when the power supply is turned on as heretofore described. In other words, it is possible to generate and display a favorable stereoscopic image for both the ordinary image input and the multiple parallax image input.

Such an image cannot be obtained in typical broadcast or the existing DVD. However, in the present embodiment, it is possible to generate multiple parallax images and display a stereoscopic image by the multiple parallax image generator unit 8 on the basis of an image signal from typical broadcast or the existing DVD, although it is pseudo. In addition, it is possible to receive multiple parallax images generated by, for example, a PC and display a clear image having a cubic effect.

### Second Embodiment

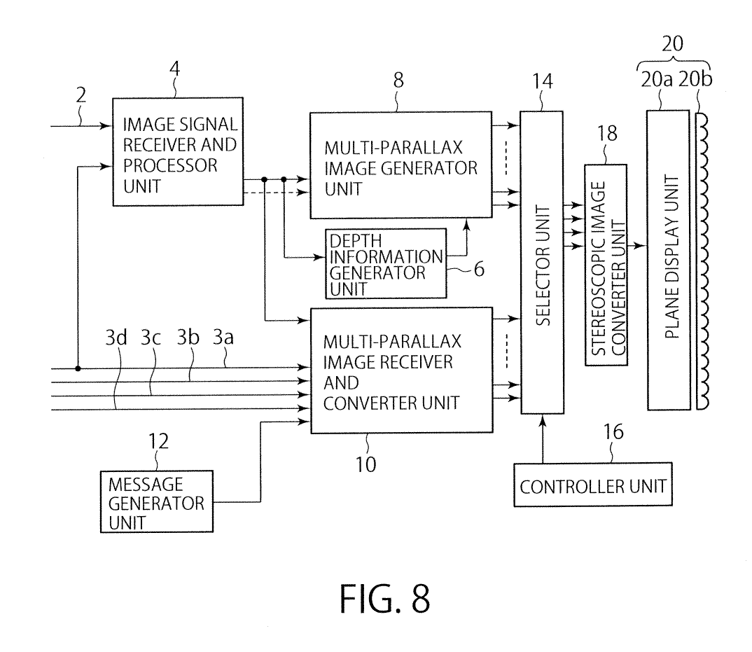

A multiple parallax image receiver apparatus according to a second embodiment is shown in FIG. 8. The multiple parallax image receiver apparatus according to the second embodiment is configured to input the multiple parallax images containing the message generated by the message generator unit 12 to the multiple parallax image receiver and converter unit 10 instead of inputting it to the selection unit 14 as in the first embodiment shown in FIG. 1.

When the power supply is turned on in the present embodiment, the multiple parallax images containing the message generated by the message generator unit 12 is sent to the multiple parallax image receiver and converter unit 10, selected by the selector unit 14, sent to the stereoscopic image converter unit 18, and converted to an image for stereoscopic image display by the stereoscopic image converter unit 18. A stereoscopic image is displayed by the plane display device 20. The stereoscopic image displayed at this time becomes a clear image having a cubic effect, because it is based on the clear multiple parallax images generated by the message generator unit 12. Furthermore, the multiple parallax images containing the message generated by the message generator unit 12 contains the message which informs the viewer that the viewer is located outside the range of a zone (viewing zone) where a normal stereoscopic image is visible. When the viewer is located outside the viewing zone, therefore, it becomes possible for the viewer to know it, view in the viewing zone, and see a normal stereoscopic image.

As for the display of a stereoscopic image by using multiple parallax images containing the message generated by the message generator unit 12, the controller unit 16 may exercise control to display the stereoscopic image for a predetermined time after the power supply is turned on and then select the multiple parallax images which are output from the multiple parallax image generator unit 8 (multiple parallax images which do not contain the multiple parallax image generated by the message generator unit 12) or the multiple parallax images which are output from the multiple parallax image receiver and converter unit 10.

Furthermore, the controller unit 16 may be controlled to select the multiple parallax images which are output from the multiple parallax image generator unit 8 (multiple parallax images which do not contain the multiple parallax images generated by the message generator unit 12) or the multiple parallax images which are output from the multiple parallax image receiver and converter unit 10, by a viewer's operation of, for example, a remote controller during the display of a stereoscopic image using the multiple parallax images generated by the message generator unit 12.

The message informing the viewer that the viewer is located outside the viewing zone may be displayed on the plane display device 20 even after the multiple parallax images which are output from the multiple parallax image generator unit 8 (multiple parallax images which do not contain the multiple parallax images generated by the message generator unit 12) or the multiple parallax images which are output from the multiple parallax image receiver and converter unit 10 are selected.

According to the present embodiment, it is possible to receive an image delivered via broadcast or a network and convert the image to multiple parallax images and display the multiple parallax images. In addition, it is possible to convert the multiple parallax images which are input, to multiple parallax images suitable for display and display the resultant multiple parallax images. In addition, it is possible to display a clear image having a cubic effect when the power supply is turned on in the same way as the first embodiment as heretofore described. In other words, it is possible to generate and display a favorable stereoscopic image for both the ordinary image input and the multiple parallax image input.

The multiple parallax image receiver apparatus according to the first embodiment and the multiple parallax image receiver apparatus according to the second embodiment have the display device. However, the multiple parallax image receiver apparatus can be used in a video recording and reproducing apparatus having no display device such as, for example, a DVD player.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A multiple parallax image receiver apparatus comprising:
an image signal receiver and processor unit configured to receive an image signal;
a multiple parallax image generator unit configured to generate first multiple parallax images based on the image signal received by the image signal receiver and processor unit;
a multiple parallax image receiver and converter unit configured to receive multiple parallax image signals and convert the received multiple parallax image signals to second multiple parallax images;
a message generator unit configured to generate third multiple parallax images containing a message to be displayed on a display device when power supply is turned on;
a selector unit configured to select and output the third multiple parallax images when the power supply is turned on, and then select and output the first or second multiple parallax images based on a control signal; and
a stereoscopic image converter unit configured to convert the multiple parallax images which are output from the selector unit to an image for stereoscopic image display.

2. The multiple parallax image receiver apparatus according to claim 1, wherein the third multiple parallax images which is output from the message generator unit is input directly to the selector unit.

3. The multiple parallax image receiver apparatus according to claim 1, wherein the third multiple parallax images which is output from the message generator unit is input to the selector unit via the multiple parallax image receiver and converter unit.

4. The multiple parallax image receiver apparatus according to claim 1, wherein the message contained in the third multiple parallax images contains an image which informs a viewer that the viewer is located outside a zone where the viewer can view a normal stereoscopic image.

5. The multiple parallax image receiver apparatus according to claim 1, wherein the image signal received by the image signal receiver and processor unit is a two-dimensional image signal delivered via broadcast or a network.

6. The multiple parallax image receiver apparatus according to claim 1, further comprising a depth information generator unit configured to generate depth information based on the image signal received by the image signal receiver and processor unit,
wherein the multiple parallax image generator unit generates multiple parallax images by using the depth information generated by the depth information generator unit.

7. The multiple parallax image receiver apparatus according to claim 1, further comprising a controller unit configured to generate the control signal based on a signal generated by a remote controller which is operated by a viewer.
